(19) United States
(12) Patent Application Publication
(10) Pub. No.: US 2008/0168877 A1
(43) Pub. Date: Jul. 17, 2008

(54) Paper Punch Die and Paper Punch With Such a Die

(75) Inventor: Kwok Ki Stephen Chan, Hong Kong (HK)

Correspondence Address: WILLIAM J. SAPONE;COLEMAN SUDOL SAPONE P.C., 714 COLORADO AVENUE, BRIDGE PORT, CT, 06605, US

(73) Assignee: LEE TACK PLASTIC & METAL MANUFACTORY LTD., Hong Kong (HK)

(21) Appl. No.: 11/623,627

(22) Filed: Jan. 16, 2007

(51) Int. Cl. B26F 1/14

(52) U.S. Cl. 83/685

(57) ABSTRACT

A paper punch die 102 is disclosed as including an upper part 104 and a lower part 106 which are fixedly secured with each other, in which the lower part 106 includes a wall 116 with a cutting edge 118, in which the upper part 104 is made of a plastics material, and the lower part 106 is made of a metal or metal alloy.

This invention relates to a paper punch die and a paper punch with such a die, in particular such a die and a paper punch suitable for paper crafting purposes.

### BACKGROUND OF THE INVENTION

In the field of paper crafting, pieces of paper or cardboard of various shapes are punched out from sheets of paper or cardboard by paper punches. A conventional paper punch is shown in FIGS. 1 and 2 and generally designated as 10. The paper punch 10 has a lever 12 operatively associated with a main body 14. A generally horizontal slot 16 is provided in the main body 14 for insertion of a sheet of paper or cardboard 18. The lever 12 may then be pivoted downwardly to move a die (not shown in FIG. 1 or 2) to punch or cut out a piece of shaped paper or cardboard 18a from the sheet of paper or cardboard 18, as shown in FIG. 3.

As can be seen in FIG. 4, which shows a sectional view of the conventional paper punch 10, a metal die 20 in the main body 14 is biased away from a die holder 24 by a spring 22 positioned between the die 20 and the die holder 24. Upon downward pivoting action of the lever 12, the die 20 will be brought to move through correspondingly sized and shaped holes in the die holder 24, against the biasing action of the spring 22, to punch out a piece of shaped paper or cardboard. Upon release of the downward force on the lever 12, the die 20 will return, under the biasing force of the spring 22, to its normal upper position.

As shown in FIGS. 5A and 5B, the die 20 has an upper flat plate 26 integrally formed with an endless wall 28. On an underside of the wall 28 is formed an undulating cutting edge 30. The die holder 24 has an upper jaw 31 and a lower jaw 32 which are joined at a rear end 34 thereof. A piece of paper or cardboard may therefore be inserted through the slot between the upper and lower jaws 31, 32 from an open front end 35 of the die holder 24. Each of the upper and lower jaws 31, 32 is formed with a hole which are aligned with each other and are so shaped and sized to just allow the wall 28 of the die 20 to pass through. Thus, when a piece of paper or cardboard is received within the slot 16 of the punch 10, upon downward movement of the lever 12, the cutting edge 30 of the die 20 will shear the piece of paper or cardboard to punch our cut out a piece of shaped paper or cardboard.

In a conventional paper punch, the die and the die holder are made of metal or metal alloy (such as copper, aluminum, silver, zinc, tin or one of their alloys) by low pressure die cast, e.g. by injection moulding. Although it has been known that the cost of the paper punch may be reduced if at least part of the die or die holder is made of a plastics material, it has long been held by people in the field that such would jeopardize proper alignment between the die and the die holder, in particular during the course of relative movement between the die and the die holder in the punching action. It is also believed that the strength and rigidity of the die may be compromised if part of it is made of a plastics material.

It is an object of the present invention to provide a paper punch die and a paper punch in which at least part of the die is made of a plastics material, while minimizing the aforesaid envisaged shortcomings, or at least to provide a useful alternative to the trade and public.

### SUMMARY OF THE INVENTION

According to a first aspect of the present invention, there is provided a paper punch die including a first body member and a second body member which are fixedly secured with each other, wherein said second body member includes a wall member with a cutting edge, wherein said first body member is made of a plastics material, and wherein said second body member is made of a metal or metal alloy.

According to a second aspect of the present invention, there is provided a paper punch including a paper punch die, a die holder, and an operating member operable to move said die relative to said die holder to punch at least a piece of paper received within said paper punch, wherein said die includes a first body member and a second body member which are fixedly secured with each other, wherein said second body member includes a wall member with a cutting edge, wherein said first body member is made of a plastics material, and wherein said second body member is made of a metal or metal alloy.

### BRIEF DESCRIPTION OF THE DRAWINGS

Preferred embodiments of the present invention will now be described, by way of examples only, with reference to the accompanying drawings, in which:

FIG. 1 is a side view of a conventional paper punch;

FIG. 2 is a top perspective view of the paper punch shown in FIG. 1;

FIG. 3 shows a piece of shaped paper as cut out from a sheet of paper by the conventional paper punch of FIG. 1;

FIG. 4 is a sectional view of the paper punch shown in FIG. 1;

FIG. 5A is a perspective view showing alignment of the die and die holder of the paper punch shown in FIG. 1;

FIG. 5B is a bottom perspective view of the die shown in FIG. 5A;

FIG. 6 is a sectional view of a paper punch with a paper punch die according to an embodiment of the present invention;

FIG. 7 is a perspective view showing alignment of the die and die holder of the paper punch shown in FIG. 6;

FIG. 8a is a top perspective view of the die of the paper punch shown in FIG. 6;

FIG. 8b is a front view of the die shown in FIG. 8a;

FIG. 8c is a sectional view of the die shown in FIG. 8a;

FIG. 8d is a top perspective view of the die of the conventional paper punch shown in FIG. 4;

FIG. 8e is a front view of the die shown in FIG. 8d;

FIG. 8f is a sectional view of the die shown in FIG. 8d;

FIG. 9a is a sectional view of the lower part of the die shown in FIG. 8a, taken along the line A-A in FIG. 9c;

FIG. 9b is an enlarged perspective view of the encircled part in FIG. 9a;

FIG. 9c is a bottom view of the die shown in FIG. 9a;

FIG. 10a is a sectional view of the die and die holder of the paper punch shown in FIG. 6 before the cutting edge of the die enters the slot of the die holder;

FIG. 10b is an enlarged view of the encircled part in FIG. 10a;

FIG. 10c is a perspective view of the part shown in FIG. 10b;

FIG. 11a is a sectional view of the die and die holder of the paper punch shown in FIG. 6, after the cutting action, and when the die is in its lowermost position relative to the die holder;

FIG. 11b is an enlarged view of the encircled part in FIG. 11a;

FIG. 11c is a perspective view of the part shown in FIG. 11b;

FIGS. 12a to 12d show lower parts of dies of various shapes and their respective die holders according to further embodiments of the present invention.

### DETAILED DESCRIPTION OF THE PREFERRED EMBODIMENTS

Although the present invention will hereinafter be referred to as and described in the context of a paper punch die and a paper punch with such a die, it is also envisaged that the present invention is also suitable for punching sheets of cardboard, and that the scope of protection should be construed accordingly.

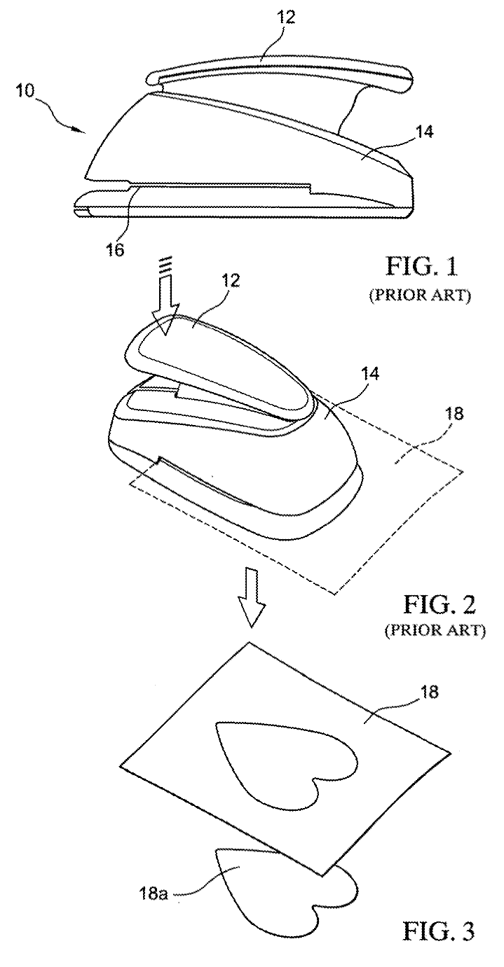

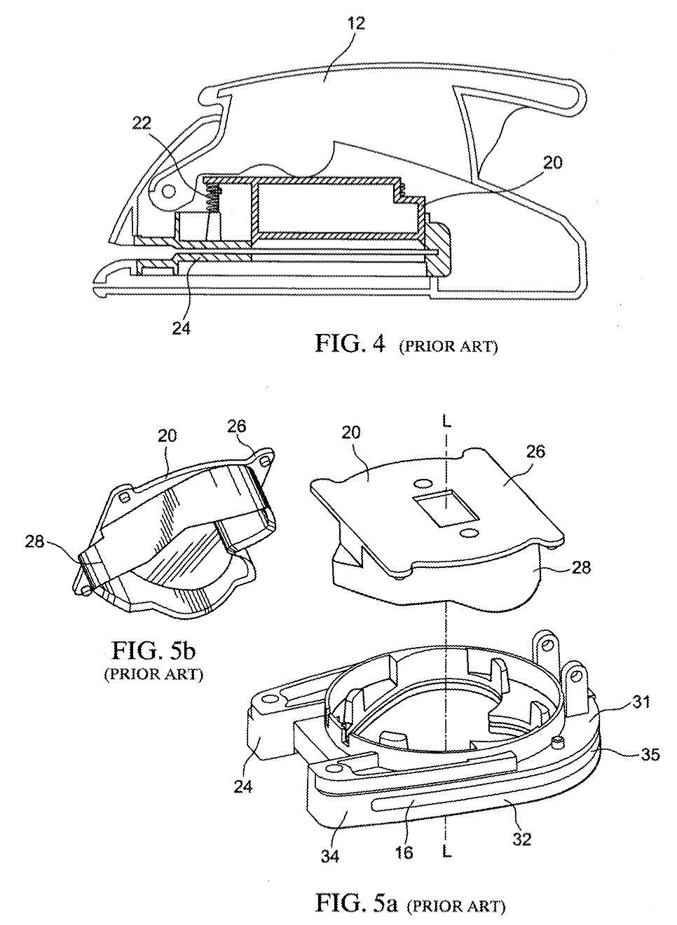

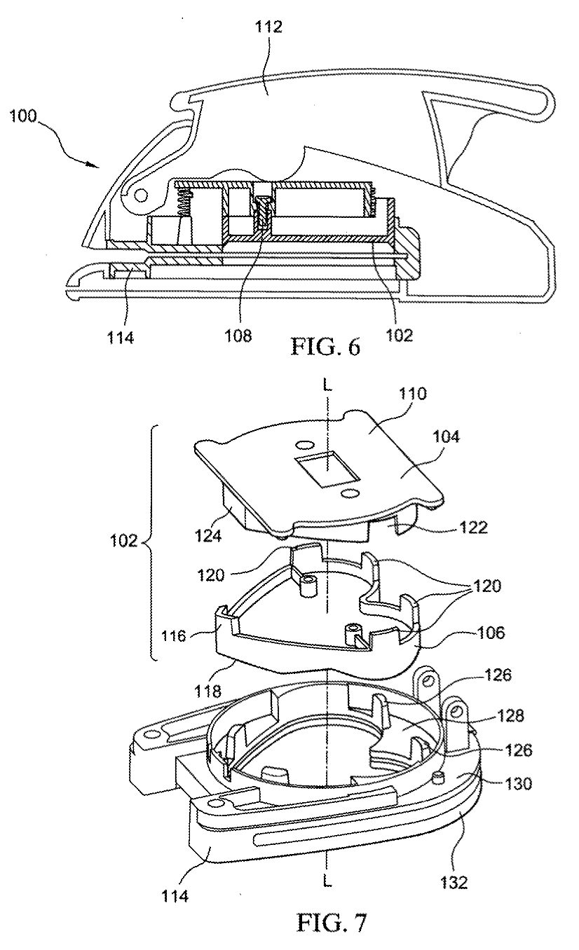

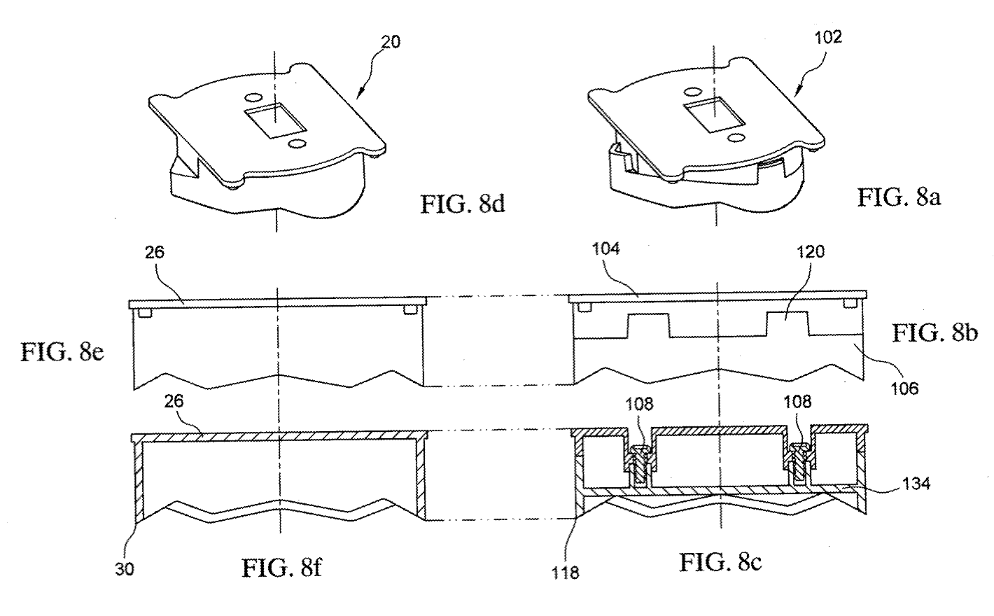

It can be seen from FIGS. 6 and 7 that the overall structure of a paper punch 100 according to the present invention is similar to the paper punch shown in FIG. 1, with the major difference being that a die 102 of the paper punch 100 is made of two parts, namely an upper part 104 and a lower part 106. The upper part 104 is made integrally of a plastics material, namely acrylonitrile-butadiene-styrene (ABS), whereas the lower part 106 is made integrally of a metal, such as copper, aluminum, silver, zinc or tin, or a metal alloy, e.g. aluminum alloy. The upper part 104 and the lower part 106 are secured with each other by a pair of screws 108 (see also FIG. 8c).

The upper part 104 has a plate 110 which is in contact with a lever 112 of the paper punch 100 so that upon pivotal movement of the lever 112, the die 102 moves relative to a die holder 114 along the axis L-L, which is parallel to the longitudinal axis of the die 102, and of the die holder 114.

The lower part 106 of the die 102 has an endless wall 116 sized and shaped to correspond with the size and shape of pieces of paper intended to be cut out by the paper punch 100. A lower side of the wall 116 is formed an undulating cutting edge 118, and a number of extensions 120 extend away from an upper side of the wall 116 in a direction parallel to the longitudinal axis of the die 102. Such extensions 120 are received into respective recesses 122 formed on a wall 124 of the upper part 104 of the die 102, for proper alignment between the upper part 104 and the lower part 106 for forming the die 102. It can be seen in FIG. 7 that a number of extensions 126 extend from an upper surface 128 of an upper jaw 130 of the die holder 114, the significance of which will be discussed below.

FIGS. 8a to 8c show various views of the die 102 of the present invention and FIGS. 8d to 8f show various corresponding views of the die 20 in the prior art paper punch 10. The dies 20, 102 are shown side by side for better comparison. It can be seen from FIGS. 8b, 8c, 8e and 8f that although the dies 20, 102 are of the same height, a metal or metal alloy planar plate 134, which is perpendicular to the longitudinal axis of the die 102 and joins the wall 116 of the die 102, is much closer to the cutting edge 118. In particular, as shown in FIG. 8c, the plate 134 is adjacent the cutting edge 118. On the other hand, in the conventional die 10, the metal plate 26 is much further away from the cutting edge 30. The positioning of the plate 134 close to the cutting edge 118 in the die 102 clearly provides further strength to the die 102, than the plate 26 does to the die 20.

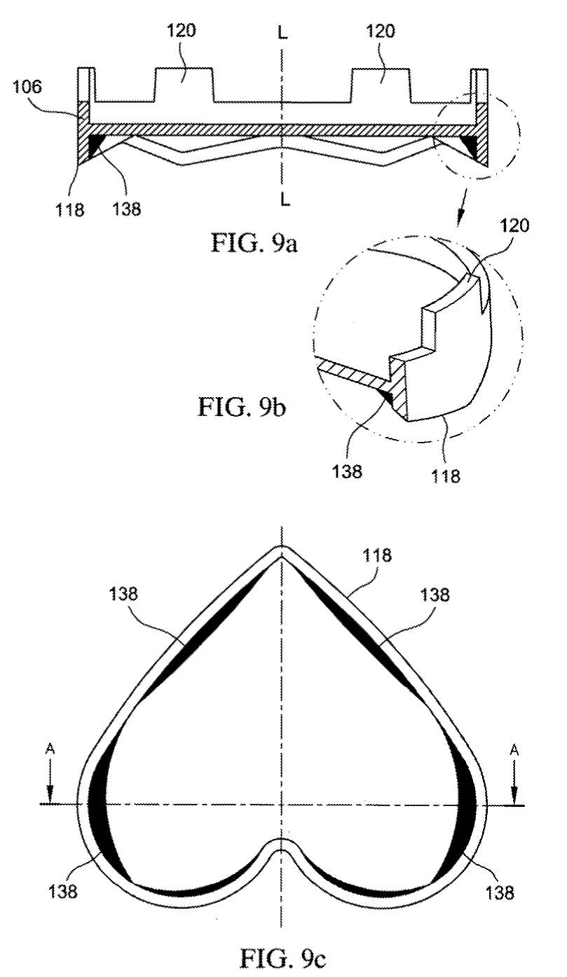

To further enhance the strength of the die 102, and as shown in FIGS. 9a to 9c, along the inner periphery of the wall 116 are provided a number of slopes 138 which join the cutting edge 118 with the plate 134. It can be seen in particular in FIGS. 9a and 9b that the outer surfaces of the slopes 138 are not parallel to the longitudinal axis L-L of the die 102.

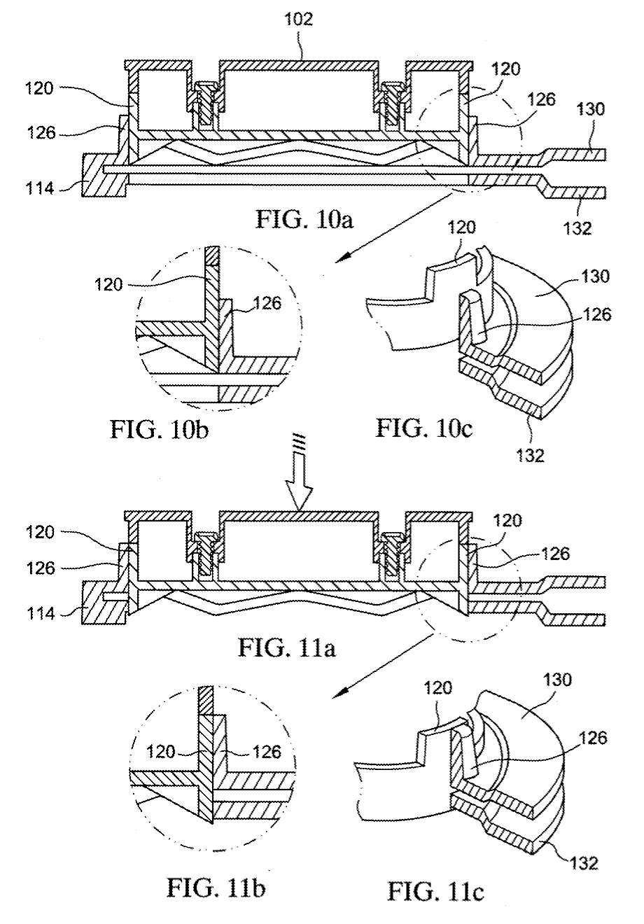

FIGS. 10a to 10c show various views of the positions of the die 102 and the die holder 114 in the normal stable position before the cutting edge 118 of the die 102 enters the slot between the upper jaw 130 and lower jaw 132 of the die holder 114. FIGS. 11a to 11c show various views of the positions of the die 102 and the die holder 114 after the cutting action, and when the die 102 is in its lowermost position relative to the die holder 114, in which the cutting edge 118 is below the slot between the upper jaw 130 and the lower jaw 132 of the die holder 114, and is, in particular, below the hole of the lower jaw 132 of the die holder 114. It can be seen from FIGS. 10a to 11c that at any time before, during or after the cutting action, the whole of the inner surfaces of the extensions 126 of the die holder 114 are always in contact with the outer surfaces of the extensions 120 of the die 102. Such an arrangement ensures proper alignment between the die 102 and the die holder 114 before, during and after the cutting action. As the lower part 106 of the die 102 is made of the same metal or metal alloy of which the die holder 114 is made, such an arrangement also ensures that the extensions 120 will not be easily worn out by reason of relative movement between the extensions 120, 126.

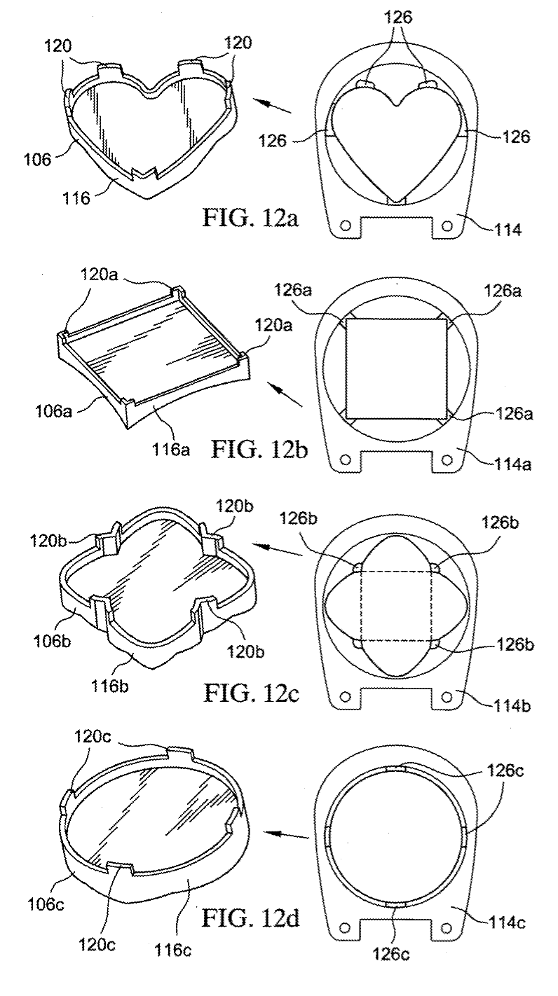

FIGS. 12a to 12d show lower parts 106, 106a, 106b, 106c of various shapes and their respective corresponding die holders 114, 114a, 114b, 114c according to the present invention. It can be seen that the respective walls 116, 116a, 116b, 116c of the lower parts 106, 106a, 106b, 106c may be of different shapes for punching pieces of paper of different shapes, as desired, such as heart shaped, square, four-leaf clover, and circular. Suitably sized and positioned extensions 126, 126a, 126b, 126c are provided in the respective die holder 114, 114a, 114b, 114c to be adjacent to and in contact with corresponding extensions 120, 120a, 120b, 120c of the respective lower part 106, 106a, 106b, 106c.

It should be understood that the above only illustrates examples whereby the present invention may be carried out, and that various modifications and/or alterations may be made thereto without departing from the spirit of the invention.

It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

1. A paper punch die including a first body member and a second body member which are fixedly secured with each other, wherein said second body member includes a wall member with a cutting edge, wherein said first body member is made of a plastics material, and wherein said second body member is made of a metal or metal alloy.

2. A die according to claim 1 wherein said wall member of said second body member is endless, wherein at least one extension extends from said wall member, and wherein said at least one extension is received at least in part in a recess of a wall member of said first body member.

3. A die according to claim 2 wherein said at least one extension is generally parallel to a longitudinal axis of said die.

4. A die according to claim 2 wherein a plurality of extensions extend from said wall member and are received at least in part in a respective recess of said side wall of said first body member.

5. A die according to claim 4 wherein said plurality of extensions are generally parallel to a longitudinal axis of said die.

6. A die according to claim 2 further including a generally planar plate member joining said wall member of said second body member.

7. A die according to claim 6 wherein said plate member is adjacent to said cutting edge.

8. A die according to claim 6 wherein said plate member is generally perpendicular to the longitudinal axis of said die.

9. A die according to claim 6 wherein said cutting edge and said plate member are joined by at least one slope which is non-parallel to the longitudinal axis of the die.

10. A die according to claim 9 wherein said cutting edge and said plate member are joined by a plurality of slopes which are non-parallel to the longitudinal axis of the die.

11. A die according to claim 1 wherein said plastics material is acrylonitrile-butadiene-styrene (ABS).

12. A paper punch including a paper punch die, a die holder, and an operating member operable to move said die relative to said die holder to punch at least a piece of paper received within said paper punch, wherein said die includes a first body member and a second body member which are fixedly secured with each other, wherein said second body member includes a wall member with a cutting edge, wherein said first body member is made of a plastics material, and wherein said second body member is made of a metal or metal alloy.

13. A paper punch according to claim 12 wherein said die holder includes an upper body member and a lower body member which are spaced apart from each other, wherein each of said upper and lower body members includes a respective hole, which are aligned with each other, allowing at least said cutting edge of said die to pass through, wherein at least one extension extends from an upper surface of said upper body member, wherein at least one extension extends from a wall member of said second body member of said die, and wherein all the inner surface of said at least one extension of said die holder is in contact with said at least one extension of said upper body member of said die holder during the course of relative movement between said die and said die holder.

14. A paper punch according to claim 13 wherein a plurality of extensions extend from said upper surface of said upper body member, wherein a plurality of extensions extend from said wall member of said second body member of said die, and wherein all the inner surface of each said extension of said die holder is in contact with said extensions of said upper body member of said die holder during the course of relative movement between said die and said die holder.
